(19) United States
(12) Patent Application Publication
(10) Pub. No.: US 2023/0127543 A1
(43) Pub. Date: Apr. 27, 2023

(54) METHOD OF IDENTIFYING TARGET DEVICE BASED ON UTTERANCE AND ELECTRONIC DEVICE THEREFOR

(71) Applicant: Samsung Electronics Co., Ltd., Suwon-si (KR)

(72) Inventors: Joohwan KIM, Suwon-si (KR); Gajin SONG, Suwon-si (KR); Hoseon SHIN, Suwon-si (KR)

(21) Appl. No.: 17/964,461

(22) Filed: Oct. 12, 2022

Related U.S. Application Data
(63) Continuation of application No. PCT/KR2022/014153, filed on Sep. 22, 2022.

(30) Foreign Application Priority Data
Oct. 26, 2021 (KR) 10-2021-0143353

(51) Int. Cl. G10L 15/22; G10L 15/18

(52) U.S. Cl. CPC G10L 15/22; G10L 15/1815; G10L 2015/223

(57) ABSTRACT

An electronic device including communication circuitry, at least one processor, and a memory that stores instructions is provided. The instructions, when executed by the at least one processor, cause the at least one processor to acquire user utterance data, identify a control function corresponding to the user utterance data by using the user utterance data, identify at least one external electronic device capable of performing the control function, determine a target device to perform the control function from the at least one external electronic device based on a state of the at least one external electronic device for the control function, and control the target device such that the target device performs the control function.

### CROSS-REFERENCE TO RELATED APPLICATION(S)

This application is a continuation application, claiming priority under § 365(c), of an International application No. PCT/KR2022/014153, filed on Sep. 22, 2022, which is based on and claims the benefit of a Korean patent application number 10-2021-0143353, filed on Oct. 26, 2021, in the Korean Intellectual Property Office, the disclosure of which is incorporated by reference herein in its entirety.

### TECHNICAL FIELD

The disclosure relates to a method of identifying a target device based on an utterance and an electronic device therefor. More particularly, the disclosure relates to a method of identifying a target device based on an intent of a user and a state of external devices, thereby improving user convenience, and increasing the frequency of use of the electronic device.

### BACKGROUND ART

Techniques for controlling an electronic device based on a voice command of a user are being widely used. For example, the electronic device may include a voice assistant configured to identify the user's intent from the user's utterance and perform an action corresponding to the identified intent. The user may easily control the electronic device using the voice command.

With more and more internet-of-things (IoT) devices, a technology of allowing a user to control another electronic device, such as an IoT device, through a voice command is widely used. A listener device, such as a mobile phone or artificial intelligence (AI) speaker, may acquire a user's utterance and control other IoT devices based on the utterance via a network, such as the Internet. For example, when the user's utterance is “Turn off the living room light”, the voice assistant may turn off the light located in the living room of the house of the user.

The above information is presented as background information only to assist with an understanding of the disclosure. No determination has been made, and no assertion is made, as to whether any of the above might be applicable as prior art with regard to the disclosure.

### DISCLOSURE OF THE INVENTION

### Technical Problem

In controlling an external electronic device based on an utterance, the voice assistant may be required to identify a target device to be controlled from the utterance. When the target device is not identified, it may be difficult to perform an action matching the intent of the utterance of the user. To identify the target device, the voice assistant may attempt to identify the target device using various pieces of information included in the utterance. For example, the voice assistant may identify the target device by using the name of the target device included in the utterance. The name of the target device may be set by the user or may be set by location information designated by the user. When the user utters “Turn off the living room television (TV)”, the voice assistant may turn off the TV that is located in the living room. As described above, a method of identifying a target device using the device name in the utterance may be referred to as a named dispatch.

In the case of the named dispatch, the utterance of the user may be complicated since the user always has to mention the target device. Since the user always has to include the name of the target device in the utterance, the user's utterance tends to be getting longer, which tends to reduce the convenience of the user. Furthermore, in a case where the listener device and the target device are the same and a case where the listener device and the target device are different, different user experiences may be provided. For example, if the listener device and the target device are the same device, which is an air conditioner, the user may control the temperature of the air conditioners by uttering “Set the temperature to 24 degrees”. On the other hand, if the listener device is a mobile phone while the target device is an air conditioner, the user needs to include information on the target device in the utterance. For example, the user may have to say “Set the temperature of the air conditioner to 24 degrees”. Since the utterance of the user for controlling the same function of the same device needs to be changed, the user may not use the voice assistant due to the complexity of the utterance.

Furthermore, as the number of devices to be controlled increases, identification of a target device may become more difficult. The user may have trouble in naming each device. In addition, if an arbitrary name is assigned to each device, it is difficult for the user to know the name of the corresponding device.

Aspects of the disclosure are to address at least the above-mentioned problems and/or disadvantages and to provide at least the advantages described below. Accordingly, an aspect of the disclosure is to provide an electronic device and a method for addressing the above-described issues.

Additional aspects will be set forth in part in the description which follows and, in part, will be apparent from the description, or may be learned by practice of the presented embodiments.

### Technical Solution

In accordance with an aspect of the disclosure, an electronic device is provided. The electronic device includes a communication circuitry, at least one processor, and a memory that stores instructions, and the instructions, when executed by the at least one processor, cause the at least one processor to acquire user utterance data, identify a control function corresponding to the user utterance data by using the user utterance data, identify at least one external electronic device capable of performing the control function, determine a target device to perform the control function from the at least one external electronic device based on a state of the at least one external electronic device for the control function, and control the target device such that the target device performs the control function by using the communication circuitry.

In accordance with another aspect of the disclosure, a method for controlling a target device of an electronic device is provided. The method includes acquiring user utterance data, identifying a control function corresponding to the user utterance data by using the user utterance data, identifying at least one external electronic device capable of performing the control function, determining a target device to perform the control function from the at least one external electronic device based on a state of the at least one external electronic device for the control function, and controlling the target device such that the target device performs the control function.

### Advantageous Effects

The electronic device according to an embodiment of the disclosure may control an external device according to an intent of the utterance of a user, thereby improving user convenience and utility of the electronic device.

The electronic device according to an example of the disclosure may identify a target device based on the intent of the user and the state of external devices, thereby improving user convenience, and increasing the frequency of use of the electronic device.

The electronic device according to an example of the disclosure may monitor a state of an external device to be a control target, thereby providing a more improved method for controlling an external device based on an utterance.

The electronic device according to an example of the disclosure may use utterance data and the state of an external device together, thereby reducing input steps of a user.

The electronic device according to an example of the disclosure may use a function and priority of an external device, thereby identifying a target device without additional user input.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an integrated intelligence system according to an embodiment of the disclosure;

FIG. 3 is a diagram illustrating a form in which information on relation between concepts and actions is stored in a database, according to an embodiment of the disclosure;

FIG. 4 is a diagram illustrating a user terminal displaying a screen for processing a voice input received through an intelligent app, according to an embodiment of the disclosure;

FIG. 5 illustrates a system for controlling a target device based on an utterance, according to an embodiment of the disclosure;

FIG. 6 illustrates a multi-device environment according to an embodiment of the disclosure;

FIG. 7 illustrates a block diagram of an electronic device according to an embodiment of the disclosure;

FIG. 8 illustrates a system for controlling an external device according to an embodiment of the disclosure;

FIG. 9 illustrates a signal flow diagram for registration of an external device according to an embodiment of the disclosure;

FIG. 10 illustrates a signal flow diagram for updating a state of an external device according to an embodiment of the disclosure;

FIG. 11 illustrates a flowchart of an available identification method according to an embodiment of the disclosure;

FIG. 12 illustrates a logic flow diagram of a music playback start function according to an embodiment of the disclosure;

FIG. 13 illustrates a logic flow diagram of a music playback stop function according to an embodiment of the disclosure;

FIG. 14 illustrates a flowchart of a method for controlling a target device of an electronic device according to an embodiment of the disclosure; and

FIG. 15 illustrates a flowchart of a method for determining a target device of an electronic device according to an embodiment of the disclosure;

Throughout the drawings, it should be noted that like reference numbers are used to depict the same or similar elements, features, and structures.

### MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

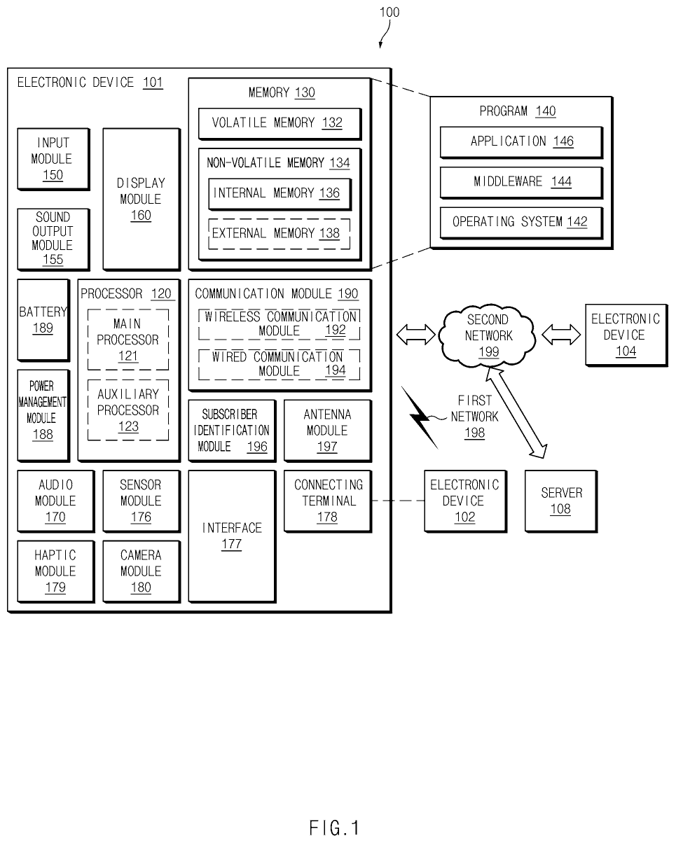

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., an external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5^{th} generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4^{th} generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

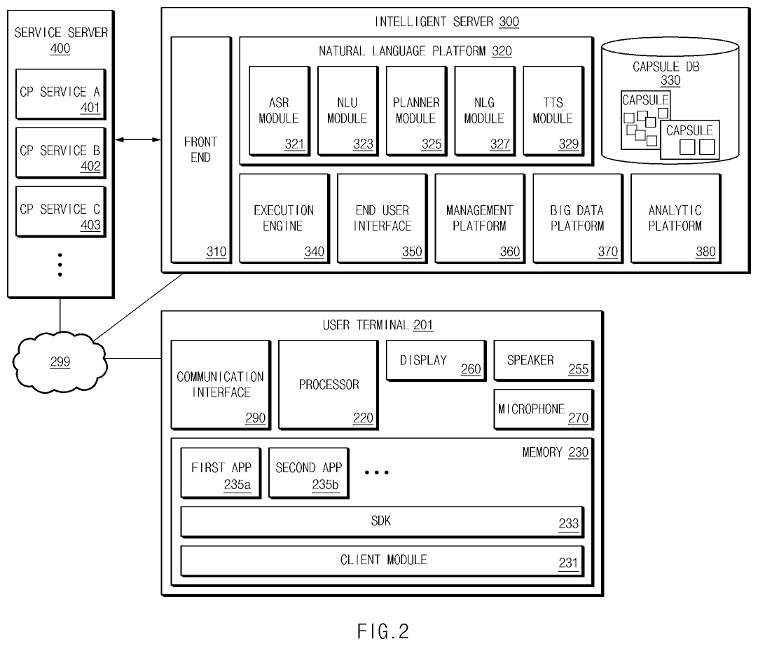

FIG. 2 is a block diagram illustrating an integrated intelligence system according to an embodiment of the disclosure.

Referring to FIG. 2, the integrated intelligent system according to an embodiment may include a user terminal 201, an intelligent server 300, and a service server 400.

The user terminal 201 (e.g., the electronic device 101 of FIG. 1) according to an embodiment may be a terminal device (or electronic device) connectable to the Internet, for example, a mobile phone, a smartphone, or a personal digital assistant (PDA), a laptop computer, a television (TV), a white home appliance, a wearable device, a head mounted device (HMD), or a smart speaker.

According to the illustrated embodiment of the disclosure, the user terminal 201 may include a communication interface 290, a microphone 270, a speaker 255, a display 260, a memory 230, and/or a processor 220. The components listed above may be operatively or electrically connected to each other.

The communication interface 290 (e.g., the communication module 190 of FIG. 1) may be configured to be connected to an external device to transmit/receive data. The microphone 270 (e.g., the audio module 170 of FIG. 1) may receive a sound (e.g., an utterance of the user) and convert the sound into an electrical signal. The speaker 255 (e.g., the sound output module 155 of FIG. 1) may output the electrical signal as a sound (e.g., voice). The display 260 (e.g., the display module 160 of FIG. 1) may be configured to display an image or video. The display 260 according to an embodiment may also display a graphic user interface (GUI) of an executed app (or an application program).

The memory 230 (e.g., the memory 130 of FIG. 1) according to an embodiment may store a client module 231, a software development kit (SDK) 233, and a plurality of applications. The client module 231 and the SDK 233 may constitute a framework (or a solution program) for performing general functions. In addition, the client module 231 or the SDK 233 may constitute a framework for processing a voice input.

The plurality of applications (e.g., 235a and 235b) may be programs for performing a specified function. According to an embodiment of the disclosure, the plurality of applications may include a first app 235a and/or a second app 235b. According to an embodiment of the disclosure, each of the plurality of applications may include a plurality of operations for performing a specified function. For example, the applications may include an alarm app, a message app, and/or a schedule app. According to an embodiment of the disclosure, the plurality of applications may be executed by the processor 220 to sequentially execute at least some of the plurality of operations.

The processor 220 according to an embodiment of the disclosure may control the overall operations of the user terminal 201. For example, the processor 220 may be electrically connected to the communication interface 290, the microphone 270, the speaker 255, and the display 260 to perform a specified operation. For example, the processor 220 may include at least one processor.

The processor 220 according to an embodiment of the disclosure may also execute a program stored in the memory 230 to perform a specified function. For example, the processor 220 may execute at least one of the client module 231 and the SDK 233 to perform the following operations for processing a voice input. The processor 220 may control operations of a plurality of applications through, for example, the SDK 233. The following operations described as operations of the client module 231 or SDK 233 may be operations performed by execution of the processor 220.

The client module 231 according to an embodiment of the disclosure may receive a voice input. For example, the client module 231 may receive a voice signal corresponding to an utterance of the user detected through the microphone 270. The client module 231 may transmit the received voice input (e.g., voice signal) to the intelligent server 300. The client module 231 may transmit, to the intelligent server 300, state information about the user terminal 201 together with the received voice input. The state information may be, for example, execution state information for an app.

The client module 231 according to an embodiment of the disclosure may receive a result corresponding to the received voice input from the intelligent server 300. For example, if the intelligent server 300 may calculate a result corresponding to the received voice input, the client module 231 may receive a result corresponding to the received voice input. The client module 231 may display the received result on the display 260.

The client module 231 according to an embodiment of the disclosure may receive a plan corresponding to the received voice input. The client module 231 may display, on the display 260, execution results of a plurality of actions of the app according to the plan. The client module 231 may, for example, sequentially display, on the display, the execution results of the plurality of actions. For another example, the user terminal 201 may display only some execution results of the plurality of actions (e.g., the result of the last action) on the display.

According to an embodiment of the disclosure, the client module 231 may receive a request for obtaining information necessary for calculating a result corresponding to the voice input from the intelligent server 300. According to an embodiment of the disclosure, the client module 231 may transmit the necessary information to the intelligent server 300 in response to the request.

The client module 231 according to an embodiment of the disclosure may transmit, to the intelligent server 300, result information obtained by executing the plurality of actions according to the plan. The intelligent server 300 may confirm that the voice input received by using the result information has been correctly processed.

The client module 231 according to an embodiment may include a speech recognition module. According to an embodiment of the disclosure, the client module 231 may recognize a voice input to perform a limited function through the speech recognition module. For example, the client module 231 may execute an intelligent app for processing a specified voice input (e.g., wake up!) by performing an organic operation in response to the voice input.

The intelligent server 300 according to an embodiment of the disclosure may receive information related to the voice input of the user from the user terminal 201 through a network 299 (e.g., the first network 198 and/or the second network 199 of FIG. 1). According to an embodiment of the disclosure, the intelligent server 300 may change data related to the received voice input into text data. According to an embodiment of the disclosure, the intelligent server 300 may generate at least one plan for performing a task corresponding to the voice input of the user based on the text data.

According to one embodiment of the disclosure, the plan may be generated by an artificial intelligent (AI) system. The artificial intelligence system may be a rule-based system, and may be a neural network-based system (e.g., a feedforward neural network (FNN), and/or a recurrent neural network (RNN)). Alternatively, the artificial intelligence system may be a combination of those described above, or another artificial intelligence system other than those described above. According to an embodiment of the disclosure, the plan may be selected from a set of predefined plans or may be generated in real time in response to a user request. For example, the artificial intelligence system may select at least one plan from among a plurality of predefined plans.

The intelligent server 300 according to an embodiment of the disclosure may transmit a result according to the generated plan to the user terminal 201 or transmit the generated plan to the user terminal 201. According to an embodiment of the disclosure, the user terminal 201 may display a result according to the plan on the display 260. According to an embodiment of the disclosure, the user terminal 201 may display, on the display 260, a result obtained by executing actions according to the plan.

The intelligent server 300 according to an embodiment may include a front end 310, a natural language platform 320, a capsule database 330, an execution engine 340, an end user interface 350, a management platform 360, a big data platform 370, or an analytic platform 380.

The front end 310 according to an embodiment of the disclosure may receive a voice input received by the user terminal 201 from the user terminal 201. The front end 310 may transmit a response corresponding to the voice input to the user terminal 201.

According to an embodiment of the disclosure, the natural language platform 320 may include an automatic speech recognition module (ASR module) 321, a natural language understanding module (NLU module) 323, a planner module 325, a natural language generator module (NLG module) 327, and/or a text-to-speech module (TTS module) 329.

The automatic speech recognition module 321 according to an embodiment may convert the voice input received from the user terminal 201 into text data. The natural language understanding module 323 according to an embodiment of the disclosure may determine an intent of the user by using text data of the voice input. For example, the natural language understanding module 323 may determine the intent of the user by performing syntactic analysis and/or semantic analysis. The natural language understanding module 323 according to an embodiment of the disclosure may identify the meaning of words by using linguistic features (e.g., grammatical elements) of morphemes or phases, and determine the intent of the user by matching the meaning of the identified word with the intent.

The planner module 325 according to an embodiment of the disclosure may generate a plan by using the intent and parameters determined by the natural language understanding module 323. According to an embodiment of the disclosure, the planner module 325 may determine a plurality of domains required to perform a task based on the determined intent. The planner module 325 may determine a plurality of actions included in each of the plurality of domains determined based on the intent. According to an embodiment of the disclosure, the planner module 325 may determine parameters required to execute the determined plurality of actions or a result value output by the execution of the plurality of actions. The parameter and the result value may be defined as a concept of a specified format (or class). Accordingly, the plan may include a plurality of actions and/or a plurality of concepts determined by the intent of the user. The planner module 325 may determine the relationship between the plurality of actions and the plurality of concepts in stages (or hierarchically). For example, the planner module 325 may determine an execution order of the plurality of actions determined based on the intent of the user based on the plurality of concepts. In other words, the planner module 325 may determine the execution order of the plurality of actions based on parameters required for execution of the plurality of actions and results output by the execution of the plurality of actions. Accordingly, the planner module 325 may generate a plan including information (e.g., ontology) on the relation between a plurality of actions and a plurality of concepts. The planner module 325 may generate the plan by using information stored in the capsule database 330 in which a set of relationships between concepts and actions is stored.

The natural language generator module 327 according to an embodiment may change specified information into a text format. The information changed to the text format may be in the form of natural language utterance. The text-to-speech module 329 according to an embodiment may change information in a text format into information in a voice format.

According to an embodiment of the disclosure, some or all of the functions of the natural language platform 320 may be implemented in the user terminal 201 as well. For example, the user terminal 201 may include an automatic speech recognition module and/or a natural language understanding module. After the user terminal 201 recognizes a voice command of the user, text information corresponding to the recognized voice command may be transmitted to the intelligent server 300. For example, the user terminal 201 may include a text-to-speech module. The user terminal 201 may receive text information from the intelligent server 300 and output the received text information as voice.

The capsule database 330 may store information on relationships between a plurality of concepts and actions corresponding to a plurality of domains. A capsule according to an embodiment may include a plurality of action objects (or action information) and/or concept objects (or concept information) included in the plan. According to an embodiment of the disclosure, the capsule database 330 may store a plurality of capsules in the form of a concept action network (CAN). According to an embodiment of the disclosure, the plurality of capsules may be stored in a function registry included in the capsule database 330.

The capsule database 330 may include a strategy registry in which strategy information necessary for determining a plan corresponding to a voice input is stored. The strategy information may include reference information for determining one plan when there are a plurality of plans corresponding to the voice input. According to an embodiment of the disclosure, the capsule database 330 may include a follow up registry in which information on a subsequent action for suggesting a subsequent action to the user in a specified situation is stored. The subsequent action may include, for example, a subsequent utterance. According to an embodiment of the disclosure, the capsule database 330 may include a layout registry that stores layout information regarding information output through the user terminal 201. According to an embodiment of the disclosure, the capsule database 330 may include a vocabulary registry in which vocabulary information included in the capsule information is stored. According to an embodiment of the disclosure, the capsule database 330 may include a dialog registry in which information regarding a dialog (or interaction) with a user is stored. The capsule database 330 may update a stored object through a developer tool. The developer tool may include, for example, a function editor for updating an action object or a concept object. The developer tool may include a vocabulary editor for updating the vocabulary. The developer tool may include a strategy editor for generating and registering strategies for determining plans. The developer tool may include a dialog editor for generating a dialog with the user. The developer tool may include a follow up editor that may edit follow-up utterances that activate subsequent goals and provide hints. The subsequent goal may be determined based on a currently set goal, a user's preference, or an environmental condition. In an embodiment of the disclosure, the capsule database 330 may be implemented in the user terminal 201 as well.

The execution engine 340 according to an embodiment of the disclosure may calculate a result by using the generated plan. The end user interface 350 may transmit the calculated result to the user terminal 201. Accordingly, the user terminal 201 may receive the result and provide the received result to the user. The management platform 360 according to an embodiment may manage information used in the intelligent server 300. The big data platform 370 according to an embodiment may collect user data. The analytic platform 380 according to an embodiment may manage the quality of service (QoS) of the intelligent server 300. For example, the analytic platform 380 may manage the components and processing speed (or efficiency) of the intelligent server 300.

The service server 400 according to an embodiment of the disclosure may provide a specified service (e.g., food order or hotel reservation) to the user terminal 201. According to an embodiment of the disclosure, the service server 400 may be a server operated by a third party. The service server 400 according to an embodiment may provide, to the intelligent server 300, information for generating a plan corresponding to the received voice input. The provided information may be stored in the capsule database 330. In addition, the service server 400 may provide result information according to the plan to the intelligent server 300. The service server 400 may communicate with the intelligent server 300 and/or the user terminal 201 through the network 299. The service server 400 may communicate with the intelligent server 300 through a separate connection. Although the service server 400 is illustrated as one server in FIG. 2, embodiments of the disclosure are not limited thereto. At least one of the respective services 401, 402, and 403 of the service server 400 may be implemented as a separate server.

In the integrated intelligent system described above, the user terminal 201 may provide various intelligent services to the user in response to a user input. The user input may include, for example, an input through a physical button, a touch input, or a voice input.

In an embodiment of the disclosure, the user terminal 201 may provide a speech recognition service through an intelligent app (or a speech recognition app) stored therein. In this case, for example, the user terminal 201 may recognize a user utterance or a voice input received through the microphone 270, and provide a service corresponding to the recognized voice input to the user.

In an embodiment of the disclosure, the user terminal 201 may perform a specified operation alone or together with the intelligent server 300 and/or the service server 400, based on the received voice input. For example, the user terminal 201 may execute an app corresponding to the received voice input and perform a specified operation through the executed app.

In an embodiment of the disclosure, when the user terminal 201 provides a service together with the intelligent server 300 and/or the service server 400, the user terminal 201 may detect a user utterance by using the microphone 270 and generate a signal (or voice data) corresponding to the detected user utterance. The user terminal 201 may transmit the voice data to the intelligent server 300 by using the communication interface 290.

In response to the voice input received from the user terminal 201, the intelligent server 300 according to an embodiment of the disclosure may generate a plan for performing a task corresponding to the voice input, or a result of performing an action according to the plan. The plan may include, for example, a plurality of actions for performing a task corresponding to the voice input of the user and/or a plurality of concepts related to the plurality of actions. The concepts may define parameters input to the execution of the plurality of actions or result values output by the execution of the plurality of actions. The plan may include relation information between a plurality of actions and/or a plurality of concepts.

The user terminal 201 according to an embodiment may receive the response by using the communication interface 290. The user terminal 201 may output a voice signal generated in the user terminal 201 by using the speaker 255 to the outside, or output an image generated in the user terminal 201 by using the display 260 to the outside.

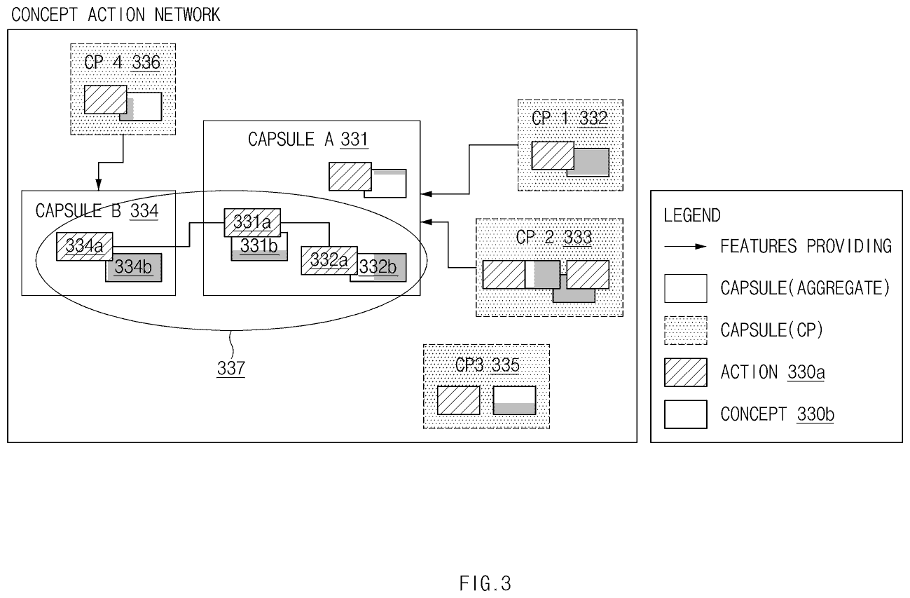

FIG. 3 is a diagram illustrating a form in which information on relation between concepts and actions is stored in a database, according to an embodiment of the disclosure.

Referring to FIG. 3, a capsule database (e.g., the capsule database 330) of the intelligent server 300 may store a capsule in the form of a concept action network (CAN). The capsule database may store an action for processing a task corresponding to a voice input of the user and a parameter necessary for the action in the form of the concept action network (CAN).

The capsule database may store a plurality of capsules (a capsule A 331 and a capsule B 334) corresponding to a plurality of domains (e.g., applications), respectively. According to an embodiment of the disclosure, one capsule (e.g., the capsule A 331) may correspond to one domain (e.g., location (geo), application). In addition, one capsule may correspond to a capsule of at least one service provider for performing a function for a domain related to the capsule (e.g., CP1 332, CP2 333, CP3 335, and/or CP4 336). According to an embodiment of the disclosure, one capsule may include at least one action 330a and at least one concept 330b for performing a specified function.

The natural language platform 320 may generate a plan for performing a task corresponding to the voice input received by using a capsule stored in the capsule database 330. For example, the planner module 325 of the natural language platform may generate a plan by using a capsule stored in the capsule database. For example, a plan 337 may be generated by using actions 331a and 332a and concepts 331b and 332b of the capsule A 331 and an action 334a and a concept 334b of the capsule B 334.

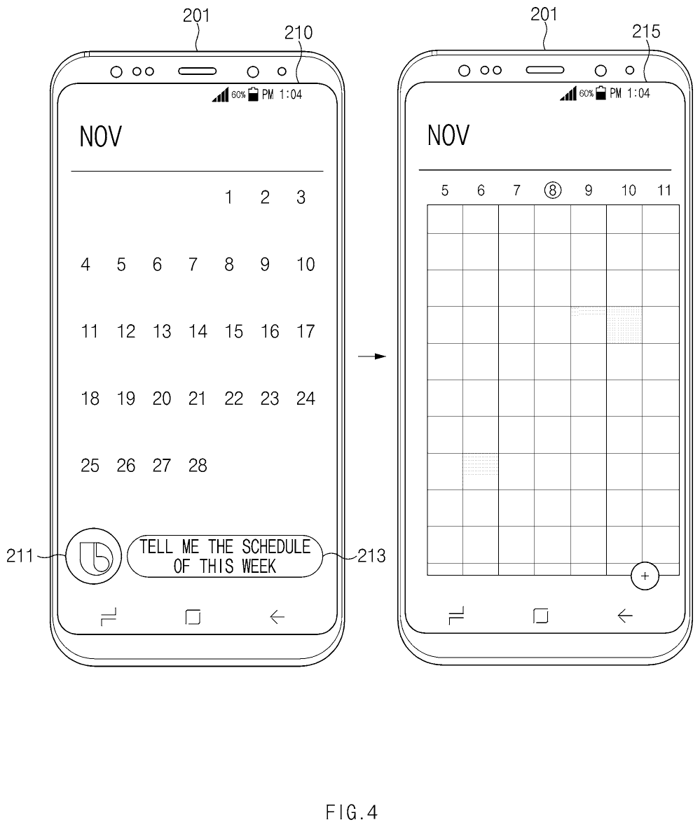

FIG. 4 is a diagram illustrating a screen in which the user terminal processes a voice input received through the intelligent app, according to an embodiment of the disclosure.

The user terminal 201 may execute an intelligent app to process the user input through the intelligent server 300.

Referring to FIG. 4, according to an embodiment of the disclosure, if a specified voice input (e.g., wake up!) is recognized or an input is received through a hardware key (e.g., dedicated hardware key), on a first screen 210, the user terminal 201 may execute the intelligent app to process the voice input. The user terminal 201 may, for example, execute the intelligent app in a state in which the schedule app is being executed. According to an embodiment of the disclosure, the user terminal 201 may display an object (e.g., an icon) 211 corresponding to the intelligent app on the display 260. According to an embodiment of the disclosure, the user terminal 201 may receive a voice input by a user utterance. For example, the user terminal 201 may receive a voice input saying “Tell me the schedule of the week!”. According to an embodiment of the disclosure, the user terminal 201 may display a user interface (UI) 213 (e.g., an input window) of the intelligent app in which text data of the received voice input is displayed on the display.

According to an embodiment of the disclosure, on a second screen 215, the user terminal 201 may display a result corresponding to the received voice input on the display. For example, the user terminal 201 may receive a plan corresponding to the received user input, and display ‘schedule of this week’ on the display according to the plan.

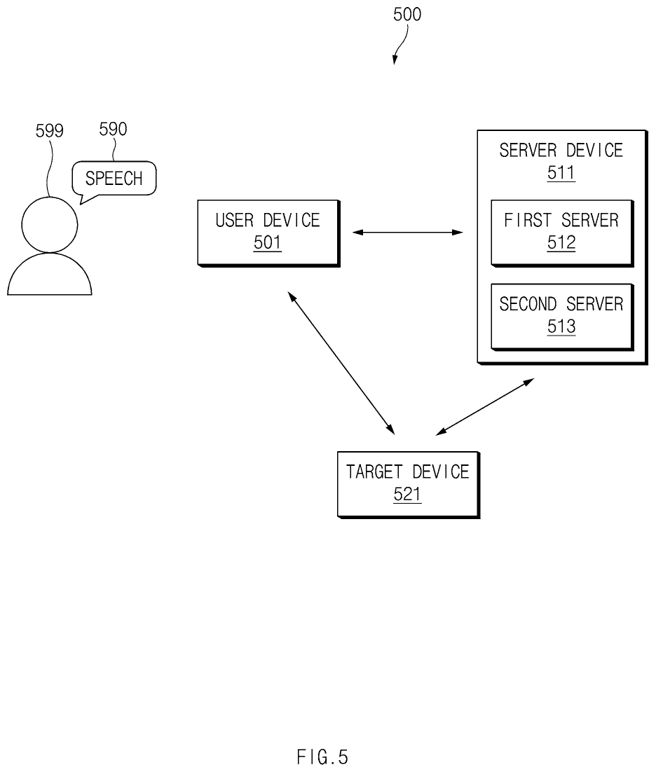

FIG. 5 illustrates a system for controlling a target device based on an utterance, according to an embodiment of the disclosure.

Referring to FIG. 5, a system 500 may include a user device 501, a server device 511, and a target device 521.

The user device 501 may be referred to as a listener device that receives utterance 590 of a user 599, and may include components similar to those of the user terminal 201 of FIG. 2 or the electronic device 101 of FIG. 1. The user device 501 may include a voice assistant (e.g., the client module 231 of FIG. 2). The user device 501 may be configured to receive the utterance 590 of the user 599 using a voice receiving circuitry (e.g., the audio module 170 of FIG. 1), and transmit utterance data corresponding to the utterance 590 to the server device 511. For example, the user device 501 may be configured to transmit utterance data to the server device 511 through a network, such as the Internet.

The target device 521 may be referred to as a device to be controlled by the utterance 590 and may include components similar to those of the electronic device 101 of FIG. 1. In various embodiments of the disclosure, the target device 521 is described as a target of control, but the target device 521 may also include a voice assistant, like the user device 501. In an example, the target device 521 may be configured to receive control data from the server device 511 through a network, such as the Internet and perform an operation according to the control data. In another example, the target device 521 may be configured to receive the control data from the user device 501 (e.g., using a local area network (e.g., NFC, Wi-Fi, LAN, Bluetooth, or D2D) or RF signal), and perform an operation according to the control data.

The server device 511 may include at least one server device. For example, the server device 511 may include a first server 512 and a second server 513. The server device 511 may be configured to receive utterance data from the user device 501 and process the utterance data. For example, the first server 512 may correspond to the intelligent server 300 of FIG. 2. The second server 513 may include a database for the external electronic devices (i.e., the target device 521). The second server 513 may be referred to as an Internet-of-things (IoT) server. For example, the second server 513 may store information about the external electronic device (e.g., an identifier of the external electronic device, group information, or the like), and may include components for controlling the external electronic device. The first server 512 may determine the intent of the user 599 included in the received utterance data by processing the received utterance data. When the intent of the user 599 is to control an external device (e.g., the target device 521), the first server 512 may use data of the second server 513 to identify the target device 521 to be controlled, and may control the target device 521 so that the identified target device 521 performs an operation according to the intent. Although the first server 512 and the second server 513 are illustrated as separate components in FIG. 5, the first server 512 and the second server 513 may be implemented as one server.

The configuration of the system 500 illustrated in FIG. 5 is exemplary, and embodiments of the disclosure are not limited thereto. Various methods for controlling the target device 521 may be included in the embodiments of the disclosure.

In an example, the utterance data transmitted by the user device 501 to the server device 511 may have any type of file format in which voice is recorded. In this case, the server device 511 may determine the intent of the user 599 for the utterance data through speech recognition and natural language analysis of the utterance data. In another example, the utterance data transmitted by the user device 501 to the server device 511 may include a recognition result of speech corresponding to the utterance 590. In this case, the user device 501 may perform automatic speech recognition on the utterance 590 and transmit a result of the automatic speech recognition to the server device 511 as the utterance data. In this case, the server device 511 may determine the intent of the user 599 for the utterance data through natural language analysis of the utterance data.

In an example, the target device 521 may be controlled based on a signal from the server device 511. When the intent of the user 599 is to control the target device 521, the server device 511 may transmit control data to the target device 521 to cause the target device 521 to perform an operation corresponding to the intent. In an example, the target device 521 may be controlled based on a signal from the user device 501. When the intent of the user 590 is to control the target device 521, the server device 511 may transmit, to the user device 501, information for controlling the target device 521. The user device 501 may control the target device 521 using the information received from the server device 511.

In an example, the user device 501 may be configured to perform automatic speech recognition and natural language understanding. The user device 501 may be configured to directly identify the intent of the user 599 from the utterance 590. In this case, the user device 501 may identify the target device 521 using the information stored in the second server 513 and control the target device 521 according to the intent. The user device 501 may control the target device 521 through the second server 513 or may directly transmit a signal to the target device 521 to control the target device 521.

In an example, the system 500 may not include the server device 511. For example, the user device 501 may be configured to perform all of the operations of the server device 511 described above. In this case, the user device 501 may be configured to identify the intent of the user 599 from the utterance 590, identify the target device 521 corresponding to the intent from an internal database, and directly control the target device 521.

The various examples described above with reference to FIG. 5 are various examples capable of controlling the target device 521 based on the utterance, and embodiments of the disclosure are not limited thereto. It should be understood to those skilled in the art that the control methods of the disclosure described below may be carried out using the system of various examples described above with reference to FIG. 5.

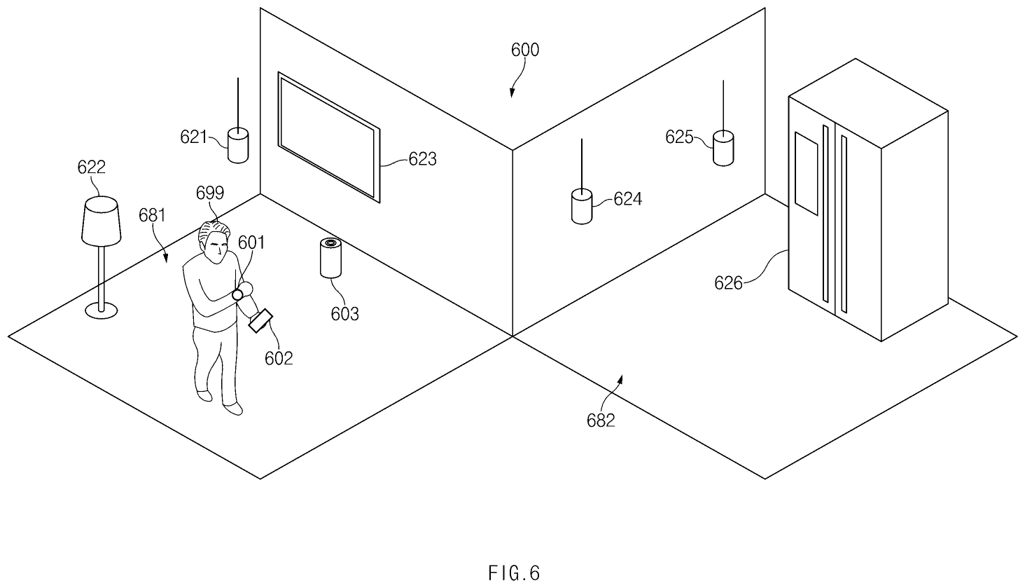

FIG. 6 illustrates a multi-device environment according to an embodiment of the disclosure.

Referring to FIG. 6, a multi-device environment 600 may include at least one listener device and at least one target device (e.g., a device to be controlled).

For example, each of a smart watch 601, a mobile phone 602, and an artificial intelligence (AI) speaker 603 may correspond to the user device 501 of FIG. 5. A user 699 may control another device using a voice assistant provided in the smart watch 601, the mobile phone 602, or the AI speaker 603. For example, the user 699 may call the voice assistant through a wake-up utterance or a user input to the listener device (e.g., a button input or a touch input), and control the other device by performing an utterance for controlling the other device.

For example, each of a first light 621, a second light 624, a third light 625, a standing lamp 622, a TV 623, and a refrigerator 626 may correspond to the target device 521 of FIG. 5. In the example of FIG. 6, the first light 621, the standing lamp 622, and the TV 623 are assumed to be located in a living room 681, and the second light 624, the third light 625, and the refrigerator 626 may be assumed to be located in a kitchen 682.

In an example, the user 699 may use the voice assistant of the mobile phone 602 to execute a voice command. If the user 699 wants to execute an application of a specified content provider (CP), the user 699 may utter a voice command instructing execution of the corresponding CP application together with the name of the corresponding CP. For example, if the name of the CP is ABC, the utterance of the user may be as follows: “Turn on ABC.” The user may perform an utterance including the name of the CP (e.g., ABC) and a command (e.g., execute, open) instructing execution of an application corresponding to the CP. In an example, the electronic device in which the corresponding CP application may be installed may be the mobile phone 602 and the TV 623. According to examples of the disclosure described below, the target device may be determined based on the availability of the CP application in the mobile phone 602 and the availability of the CP application in the TV 623. If the application of ABC is not installed on the TV 623 but the application of ABC is installed on the mobile phone 602, the mobile phone 602 may execute the application of ABC on the mobile phone 602. This is because the application of ABC is not installed on the TV 623.

In an example, the user 699 may use the voice assistant of the mobile phone 602 to execute a voice command. If the user 699 wants to stop playing music, the user 699 may utter a voice command instructing to stop playing music. For example, the utterance of the user may be as follows: “Stop music.” In an example, the electronic device capable of playing music may be the TV 623 and the AI speaker 603. According to examples of the disclosure described below, the target device may be determined based on the availability of a music playback stop function in the TV 623 and the AI speaker 603. For example, if music is being played on the TV 623 while music is not being played on the AI speaker 603, the mobile phone 602 may control the TV 623 to stop music playback. For an example, if music is being played on the AI speaker 603 while music is not being played on the TV 623, the mobile device 602 may control the AI speaker 603 to stop music playback.

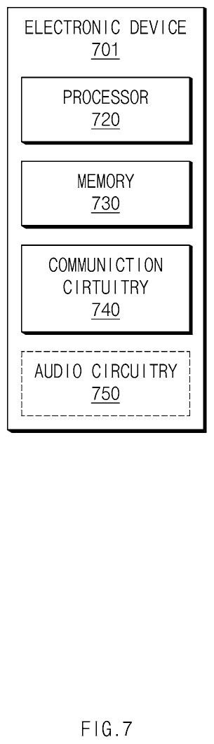

In examples of the disclosure, different target devices may be determined based on the availability even for the same utterance. Hereinafter, methods for identifying the target device may be described with reference to FIGS. 7 to 15. Controlling another device by a specified device in the disclosure may include direct controlling and indirect controlling. For example, controlling the TV 623 by the mobile phone 602 may include both cases where the mobile phone 602 directly transmits a signal to the TV 623 to control the TV 623, and where the mobile phone 602 controls the TV 623 through an external device (e.g., the server device 511 of FIG. 5).

FIG. 7 illustrates a block diagram of an electronic device according to an embodiment of the disclosure.

Referring to FIG. 7, according to an embodiment of the disclosure, an electronic device 701 may include a processor 720 (e.g., the processor 120 of FIG. 1), a memory 730 (e.g., the memory 130 of FIG. 1), and/or a communication circuitry 740 (e.g., the communication module 190 of FIG. 1). For example, the electronic device 701 may further include an audio circuitry 750 (e.g., the audio module 170 of FIG. 1), and may further include a component not shown in FIG. 7. For example, the electronic device 701 may further include at least some components of the electronic device 101 of FIG. 1.

In various embodiments of the disclosure, the electronic device 701 may be referred to as a device for identifying and/or determining a target device (e.g., the target device 521 of FIG. 5). For example, if identification and/or determination of the target device is performed in a server device (e.g., the server device 511 of FIG. 5), the electronic device 701 may be referred to as a server device. For example, if identification and/or determination of the target device is performed in a user device (e.g., the user device 501 of FIG. 5), the electronic device 701 may be referred to as a user device. As described above, after the target device is identified, control of the target device may be performed using another device. Accordingly, the electronic device 701 may control the target device directly or may control the target device through another device.

The processor 720 may be electrically, operatively, or functionally connected to the memory 730, the communication circuitry 740, and/or the audio circuitry 750. The memory 730 may store instructions. When the instructions are executed by the processor 720, the instructions may cause the electronic device 701 to perform various operations.

The electronic device 701 may, for example, acquire user utterance data and identify a control function corresponding to the user utterance data by using the user utterance data. The electronic device 701 may acquire the user utterance data by using the audio circuitry 750 or may acquire utterance data from an external electronic device by using the communication circuitry 740. The electronic device 701 may be configured to identify an intent corresponding to the user utterance data, identify the control function corresponding to the intent, and identify at least one external electronic device supporting the control function by using function information on a plurality of external electronic devices.

The electronic device 701 may identify at least one external electronic device capable of performing the control function, and determine a target device for performing the control function among the at least one external electronic device, based on a state of the at least one external electronic device for the control function. For example, the electronic device 701 may be configured to identify availability of the control function of each of the at least one external electronic device, and determine, as the target device, an external electronic device available for the control function from the at least one external electronic device.

The electronic device 701 may be configured to determine the target device based on a priority if the at least one external electronic device includes a plurality of external electronic devices. For example, the electronic device 701 may be configured to determine a listener device acquiring the user utterance data as the target device if the listener device is included among the plurality of external electronic devices. For example, the electronic device 701 may be configured to receive the user utterance data from the listener device, receive location information about the listener device from the listener device, and determine, as the target device, an external electronic device closest to the listener device among the plurality of external electronic devices by using the location information. For example, the electronic device 701 may be configured to determine, as the target device, an external electronic device that is most frequently used, among the plurality of external electronic devices.

The electronic device 701 may be configured to receive attribute information about each of the at least one external electronic device from each of the at least one external electronic device, and update availability associated with functions of each of the at least one external electronic device by using each piece of the attribute information. For example, the electronic device 701 may be configured to update the availability by executing execution logic associated with each of the functions using the attribute information. For example, the execution logic may be a preset logic for determining availability of a function corresponding to the execution logic using the attribute information as a parameter.

The electronic device 701 may control the target device such that the target device performs the control function by using the communication circuitry 740. For example, the electronic device 701 may be configured to control the target device by using the communication circuitry 740 to transmit, to the target device directly or indirectly, a signal instructing to perform the control function.

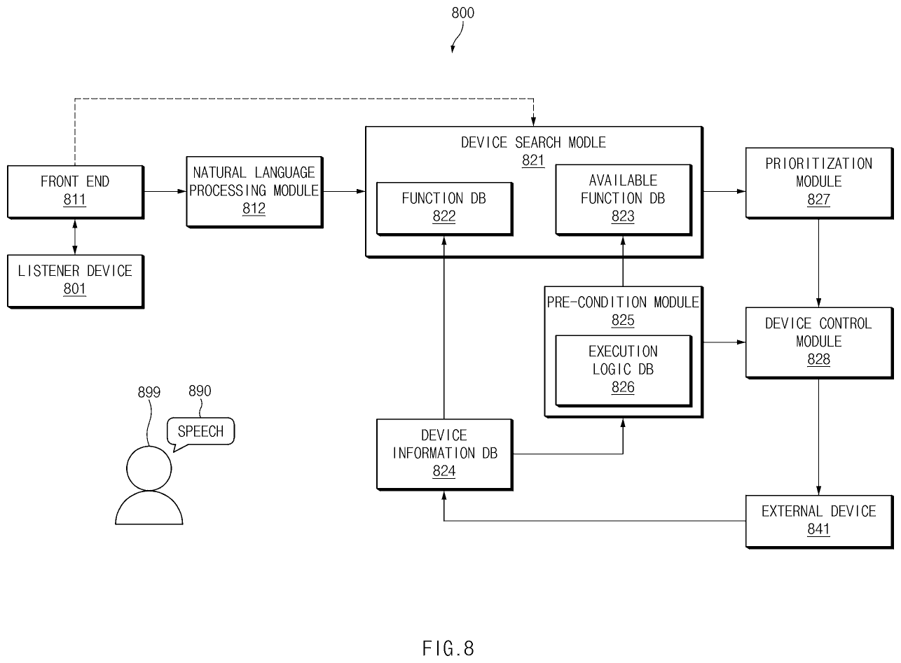

FIG. 8 illustrates a system for controlling an external device according to an embodiment of the disclosure.

Referring to FIG. 8, a system 800 may include various modules for controlling an external device 841 based on an utterance 890 of a user 899. The term “module” of FIG. 8 refers to a software module, and may be implemented by instructions being executed by a processor. Each module may be implemented on the same hardware or may be implemented on different hardwares.

In an embodiment of the disclosure, the server device (e.g., the server device 511 in FIG. 5) includes a front end 811, a natural language processing module 812, a device search module 821, a device information database (DB) 824, a pre-condition module 825, a prioritization module 827, and a device control module 828.

The listener device 801 is a device in which a voice assistant is installed, and may receive the utterance 890 of the user 899 and transmit utterance data corresponding to the utterance 890 to a server device (e.g., the first server 512 in FIG. 5). For example, the listener device 801 may activate a voice assistant application and activate a microphone (e.g., the audio circuitry 750 of FIG. 7), in response to a wake-up utterance, a button input, or a touch input. The listener device 801 may transmit utterance data corresponding to the received, by using the microphone, utterance 890 to the server device. The listener device 801 may transmit, to the server device, information about the listener device 801 together with the utterance data. For example, the information about the listener device 801 may include an identifier of the listener device, a list of functions of the listener device, a status of the listener device (e.g., power status, playback status), and/or location information (e.g., latitude and longitude, or information on a connected access point (AP) (e.g., service set identifier (SSID))). The listener device 801 may provide a result, processed by the server, to the user 899 through a speaker or a display. The result, processed by the server, may include a natural language expression indicating the result of the utterance 890 being processed.

If a front end 811 (e.g., the front end 310 in FIG. 2) receives a voice processing request (e.g., utterance data) from the listener device 801, a connection session between the server device and the listener device 801 may be maintained. The front end 811 may temporarily store the information received from the listener device 801 and provide the received information to other modules. For example, information about the listener device 801 of the front end 811 may be transmitted to the device search module 821. If the utterance data is processed by the server device, the server device may transmit the result of processing on the utterance data to the listener device 801 through the front end 811.

The natural language processing module 812 may identify user intent based on the utterance data received from the listener device 801. For example, the natural language processing module 812 may correspond to the intelligent server 300 of FIG. 2 (e.g., the first server 512 of FIG. 5). The natural language processing module 812 may generate text data from the utterance data by performing speech recognition on the utterance data. The natural language processing module 812 may identify the intent of the user by performing natural language understanding on the text data. For example, the natural language processing module 812 may identify an intent corresponding to the utterance 890 by comparing a plurality of predefined intents with the text data. Further, the natural language processing module 812 may extract additional information from the utterance data. For example, the natural language processing module 812 may perform slot tagging or slot filling by extracting words (e.g., entities) included in the utterance data. Table 1 below shows examples of intents classified from utterances (e.g., the text data) by the natural language processing module 812 and extracted additional information (e.g., entities).

TABLE 1

| Utterance | Classified Intent | Extracted Entity |
|---|---|---|
| Robot vacuum cleaner, | Cleaning-Start | Robot Vacuum Cleaner |
| Start cleaning | | |
| Start Cleaning | Cleaning-Start | — |
| Stop playing the TV | MediaPlay-Stop | TV in Living Room |
| in the living room | | |
| Stop playing | MediaPlay-Stop | — |
| Open the door | Door-Open | |

The natural language processing module 812 may transmit the identified intent to the device search module 821. For example, if the identified intent corresponds to control of an external device, the natural language processing module 812 may transmit the identified intent to the device search module 821. The natural language processing module 812 may transmit the identified intent and the extracted additional information (e.g., entity) to the device search module 821.

The device search module 821 may identify an external electronic device capable of performing the intent of the user 899 by using information (intent and/or additional information) received from the natural language processing module 812. The device search module 821 may be included in, for example, a server device (e.g., the second server 513 in FIG. 5) together with the pre-condition module 825, the device control module 828, and the device information DB 824.

The function DB 822 may store a list of functions of each of a plurality of external devices. The list of functions may be stored in association with an account (e.g., an account of the user 899). As an example, a plurality of external electronic devices may be associated with one account. For example, a plurality of external electronic devices registered in the account of the user 899 may be stored in the function DB 822. The function DB 822 may include a list of functions of each of a plurality of external electronic devices. For example, if an external electronic device is added or deleted to or from one user account, the list of functions list associated with the corresponding account may be updated.

An available function database (DB) 823 may store information on an available state for each of the functions of the function DB 822. For example, a function of a specified device may indicate an available state or a non-available state. With a change in the state of a specified external device, the functional state of the available function DB 823 may be changed.

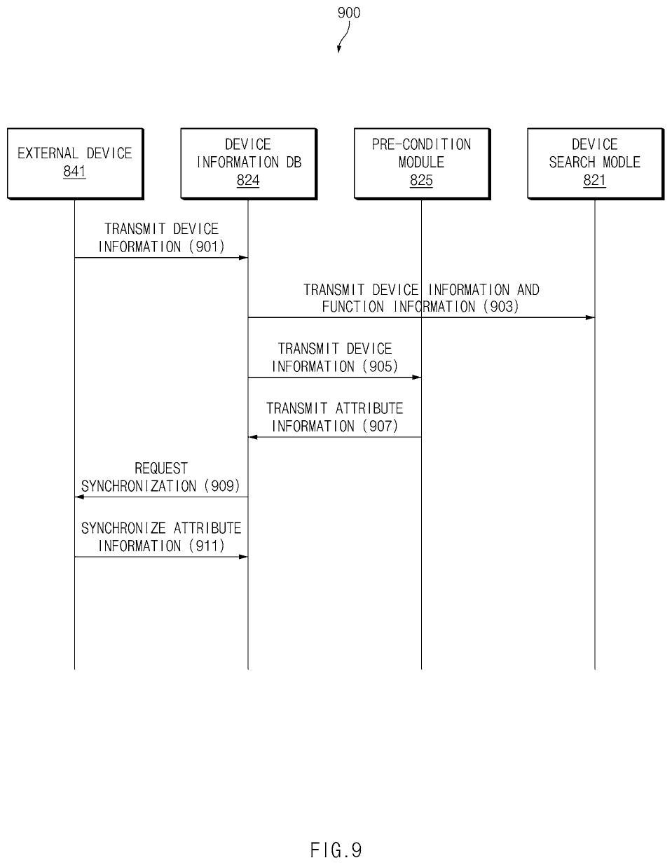

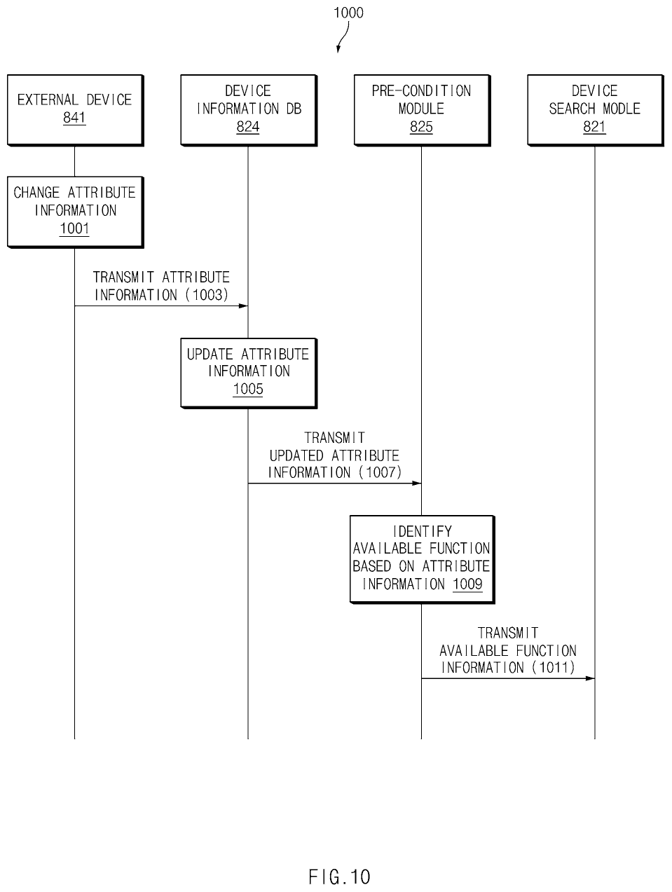

The update of the function DB 822 and the available function DB 823 may be described later with reference to FIGS. 9 and 10. In FIG. 8, the function DB 822 and the available function DB 823 are shown as being included in the device search module 821, but the function DB 822 and the available function DB 823 may be implemented in a device different from the device search module 821.

According to an embodiment of the disclosure, the device search module 821 may identify at least one external electronic device corresponding to the intent received from the natural language processing module 812 by using the intent. For example, the device search module 821 may identify at least one external electronic device corresponding to the intent by using information on mapping of the function to the intent. Table 2 below shows an intent-function mapping relationship according to an example.

TABLE 2

| Intent | Mapped Device Functions |
|---|---|
| Cleaning-Start | Robot Vacuum Mode on |
| | Washer Cleaning Mode |
| | Robot Vacuum Mode off |
| Mediaplay-Start | TV Music Player Start |
| | TV Video Player Start |
| | Speaker Music Player Start |
| Mediaplay-Stop | TV Music Player Stop |
| | TV Video Player Stop |
| | Speaker Music Player Stop |
| Door-Open | Garage Door Open |
| | Door-lock Unlock |
| | Refrigerator Door Open |

For example, if the identified intent is Mediaplay-Start, the device search module 821 may identify the TV and the speaker as external devices corresponding to the intent by using the mapping information. If the utterance data indicates a device of a specified type, the device search module 821 may determine the target device using additional data (e.g., entity).

The device search module 821 may determine whether the identified external device is in a state of being capable of performing the intent by using the available function DB 823. For example, if the utterance data does not refer to a specified device, the device search module 821 may identify and/or determine the target device by using the available function DB 823. For example, Table 3 below shows available function information according to an example.

TABLE 3

| Function | Availability |
|---|---|
| Robot Vacuum Mode on | TRUE |
| Washer Cleaning Mode | TRUE |
| Robot Vacuum Mode off | TRUE |
| TV Music Player Start | FALSE |
| TV Video Player Start | FALSE |
| Speaker Music Player Start | TRUE |
| TV Music Player Stop | TRUE |
| TV Video Player Stop | TRUE |
| Speaker Music Player Stop | FALSE |
| Garage Door Open | TRUE |
| Door-lock Unlock | TRUE |
| Refrigerator Door Open | TRUE |

For example, if the identified intent is Mediaplay-Start, the device search module 821 may identify the function corresponding to the intent as TV Music Player Start, TV Video Player Start, and Speaker Music Player Start according to the mapping information in Table 2. The device search module 821 may use the availability of Table 3 to identify the available function as Speaker Music Player Start. Accordingly, the device search module 821 may identify the speaker as the target device corresponding to the utterance 890.

The device search module 821 may transmit information about the identified target device to the prioritization module 827. For example, if only one target device is identified, the device search module 821 may transmit information about the target device to the device control module 828 without going through the prioritization module 827. For example, if a plurality of target devices are identified, the device search module 821 may transmit information about the plurality of target devices to the prioritization module 827. The prioritization module 827 may determine one target device from a plurality of target devices (e.g., a plurality of candidate target devices) based on the priority.

For example, the prioritization module 827 may determine the target device based on information about the listener device 801. For example, the prioritization module 827 may give the highest priority to the listener device 801. If the listener device 801 is included in the plurality of target devices, the prioritization module 827 may identify and/or determine the listener device 801 as a target device to be controlled. For another example, the prioritization module 827 may determine a candidate device closest to the listener device 801 as the target device. The prioritization module 827 may acquire location information about external electronic devices from the device information DB 824 and determine the closest external electronic device by comparing the acquired location information about the external electronic devices with the location of the listener device 801. The prioritization module 827 may identify the closest external electronic device by using latitude and longitude information and/or geo-fencing information.

For example, the prioritization module 827 may determine the target device based on a usage history. The prioritization module 827 may determine, as the target device, a candidate target device that is most frequently used, from a plurality of candidate target devices.

The device control module 828 may control the external device to perform a function corresponding to the intent of the utterance 890. For example, the device control module 828 may transmit, to the target device, a control command for performing a function corresponding to an intent through a network (e.g., the Internet). If the target device is the listener device 801, the device control module 828 may transmit the control command to the listener device 801. If the target device is the external device 841, the device control module 828 may transmit the control command to the external device 841.

The device information DB 824 may store information about an external device. The information about the external device may include an identifier, a type (e.g., TV, speaker, vacuum cleaner, or the like), name, and/or location information about the external device. The information about the external device may include attribute information (e.g., a state) for the external device. The device information DB 824 may be configured to acquire, for example, from the pre-condition module 825, information on an attribute to be monitored of the external device upon initial connection with the external device, and receive and monitor the acquired attribute from the external device. A state information acquisition method for the device information DB 824 may be described later with reference to FIG. 9.

The location information stored in the device information DB 824 may include latitude and longitude information, location information set by the user (e.g., living room, kitchen, company, or the like), and/or geo-fence information (e.g., access point (AP)-based information and/or cellular network connection-based information). Information about the external device may be stored in association with account information. For example, the information about the external device may be stored by being mapped to an associated user account. The prioritization module 827 may determine the target device by using the information about an external device stored in the device information DB 824.

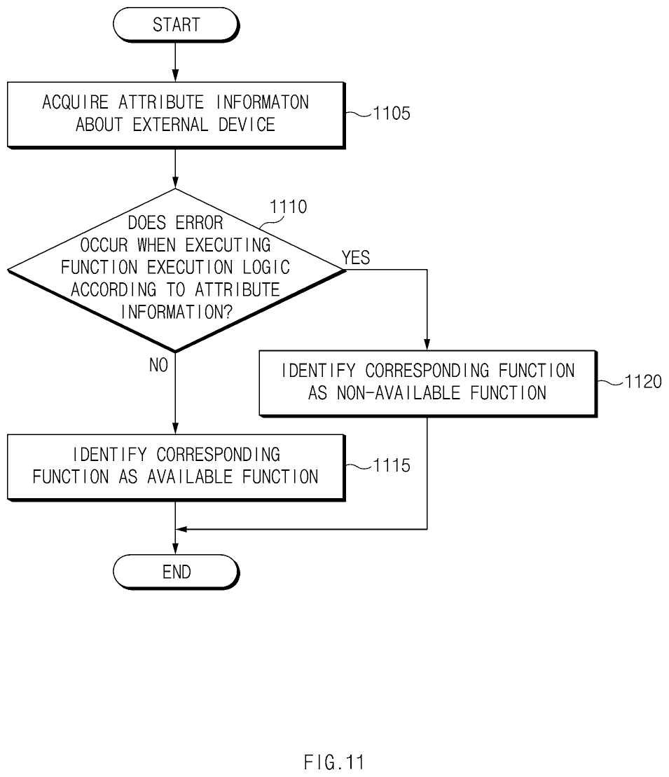

The pre-condition module 825 may include an execution logic DB 826. The execution logic DB 826 may store execution logic of the corresponding external device set by the manufacturer of the external device. The execution logic may define a logical flow in which a corresponding external device performs a specified function according to a specified voice command. The pre-condition module 825 may store information on a parameter (e.g., attribute) required for a specified external device (e.g., an external device of a specified type or a specified model) to perform functions. For example, the pre-condition module 825 may be configured to transmit information on attribute required for execution logic for a specified external device in the device information DB 824. The pre-condition module 825 may be configured to identify available functions of the external device by using the attributes of the external device, as described below with reference to FIGS. 11, 12, and 13. The pre-condition module 825 may update the available function DB 823 by using the identified available functions.

In the embodiment described above, the server device (e.g., the server device 511 in FIG. 5) has been described as including the front end 811, the natural language processing module 812, the device search module 821, the device information database (DB) 824, the pre-condition module 825, the prioritization module 827, and the device control module 828. In this case, the electronic device 701 described above with reference to FIG. 7 may be referred to as a server device. However, embodiments of the disclosure are not limited thereto. A device that performs an operation for identifying the target device (e.g., an operation(s) of the device search module 821 and/or the prioritization module 827) may correspond to the electronic device 701 of FIG. 7. For example, identification of the target device may be performed by the listener device 801. In this case, the electronic device 701 of FIG. 7 may be referred to as the listener device 801 or the user device 501 of FIG. 5.

FIG. 9 illustrates a signal flow diagram for registration of an external device according to an embodiment of the disclosure.

Referring to a signal flow diagram 900 of FIG. 9, according to an embodiment of the disclosure, if the external device 841 is registered or connected to the user's account, a list of device functions of the external device 841 of the system (e.g., the system 800 of FIG. 8) may be registered, and device attributes associated with the list of functions may be monitored.

In operation 901, the external device 841 may transmit device information to the device information DB 824. For example, the external device 841 may transmit device information to the device information DB 824 when the external device 841 is registered or connected to a user's account. The device information may include, for example, an identifier, a type (e.g., TV, speaker, vacuum cleaner, or the like), name, and/or location information about the external device 841. The location information may include latitude and longitude information, location information set by the user (e.g., living room, kitchen, company, or the like), and/or geo-fence information (e.g., access point (AP)-based information and/or cellular network connection-based information).

In operation 903, the device information DB 824 may transmit device information and function information to the device search module 821. For example, the device information DB 824 may acquire function information about the external device 841 by using model information about the external device 841. The function information may include a list of functions that may be executed by the external device 841. For another example, the device information DB 824 may receive the function information from the external device 841. The device search module 821 may store the received device information and function information in the function DB 822.

In operation 905, the device information DB 824 may transmit the device information to the pre-condition module 825. By transmitting the device information, the device information DB 824 may request attribute information required for monitoring the external device 841. The pre-condition module 825 may identify streams of execution logic of the external device 841 by using device information (e.g., model information), and identify attributes (e.g., parameters) of the external device 841 used for the identified streams of execution logic.

In operation 907, the pre-condition module 825 may transmit attribute information to the device information DB 824. The attribute information may include an attribute (e.g., a state) of the external device 841 for performing streams of execution logic of the external device 841.

In operation 909, the device information DB 824 may transmit a synchronization request to the external device 841. The synchronization request may include attribute information received from the pre-condition module 825. By transmitting the synchronization request, the device information DB 824 may inform the external device 841 of an attribute that synchronization is required. For example, the attribute information may include at least one of a power state (e.g., on/off) of the external device 841, an execution state of a specified function (e.g., playing), and/or an attribute (e.g., volume) associated with the specified function.

In operation 911, the external device 841 may synchronize the attribute information with the device information DB 824 by using the attribute information included in the synchronization request. For example, the external device 841 may synchronize the attribute information by transmitting the current state of the attribute requested by the synchronization request to the device information DB 824.

This registration procedure of the external device 841 may be referred to as on-boarding. When the registration of the external device 841 is completed, the device information DB 824 may transmit the attribute information to the pre-condition module 825 (e.g., operation 1007 of FIG. 10). The pre-condition module 825 may identify an available function by using the attribute information (e.g., operation 1009 of FIG. 10), and update the available function in the available function DB 823.

FIG. 10 illustrates a signal flow diagram for updating a state of an external device according to an embodiment of the disclosure.

Referring to a signal flow diagram 1000 of FIG. 10, according to an embodiment of the disclosure, if the external device 841 is registered or connected to the user's account, device attributes associated with the list of functions of the external device 841 of the system (e.g., the system 800 of FIG. 8) may be monitored.

In operation 1001, attribute information about the external device 841 may be changed. For example, if the external device 841 performs or stops a specified function, the attribute information may be changed. If the external device 841 is powered on or off, the attribute information may be changed. In various embodiments of the disclosure, the attribute to be updated in the attribute information may be an attribute for which synchronization is requested by the device information DB 824.

In operation 1003, the external device 841 may transmit the attribute information to the device information DB 824 in response to the change of the attribute information. For example, if power is to be turned off, the external device 841 may transmit the attribute information before power-off of the external device 841 and then may be powered off. For example, the external device 841 may be a TV. The user may play music using the TV in a power-on state. In this case, the TV may set the attribute of the music player of the TV to a playing state and transmit the set attribute to the device information DB 824.

In operation 1005, the device information DB 824 may update the attribute information using the received attribute information. In operation 1007, the device information DB 824 may transmit the updated attribute information to the pre-condition module 825. In this case, the device information DB 824 may transmit, to the pre-condition module 825, not only the updated attribute information, but also non-updated pre-stored attribute information.

In operation 1009, the pre-condition module 825 may identify an available function based on the attribute information. For example, the pre-condition module 825 may perform the streams of execution logic of the external device 841 by using the received attribute information, and identify the availability of a function corresponding to each stream of execution logic based on the execution functions of the streams of execution logic. A method of identifying availability may be described with reference to FIGS. 11, 12, and 13.

In operation 1011, the pre-condition module 825 may transmit available function information to the device search module 821. The available function may include information on the updated available function based on the updated attribute information. The device search module 821 may store the received available function information in the available function DB 823. The attributes of the external device 841 may be synchronized with the system by the operations described above with reference to FIG. 10.

Referring to FIG. 10, the external device 841 has been described as transmitting the attribute information if an attribute is changed, but embodiments of the disclosure are not limited thereto. For example, the external device 841 may be configured to transmit the attribute information according to at a specified period. Further, the listener device (e.g., the listener device 801 of FIG. 8) may synchronize the attribute information by transmitting the attribute information. For example, the listener device may be configured to transmit the attribute information to the system when a user utterance is received. The attribute information allows the system to identify available functions of the listener device. For another example, the listener device may be configured to transmit the available function information to the system based on any trigger (e.g., user input, specified period, and/or attribute change).

FIG. 11 illustrates a flowchart of an available identification method according to an embodiment of the disclosure.

Referring to FIGS. 8 and 11, according to an embodiment of the disclosure, the pre-condition module 825 may identify an available function of the external device 841 by using attribute information.

In operation 1105, the pre-condition module 825 may acquire attribute information about the external device 841. For example, the pre-condition module 825 may receive the attribute information from the external device 841. The pre-condition module 825 may receive the attribute information from the external device 841 through the device information DB 824.

In operation 1110, the pre-condition module 825 may determine whether an error occurs when executing the function execution logic according to the attribute information. The attribute information may be used as a parameter of the function execution logic. Each piece of function execution logic may include at least one condition that may generate an error according to each attribute. Accordingly, if the attribute information does not satisfy at least one condition, the function execution logic may return an error.

If an error does not occur when the updated attribute information is input and executed in the function execution logic corresponding to the specified function (e.g., NO in operation 1110), in operation 1115, the pre-condition module 825 may identify the corresponding function as an available function. If an error occurs when the updated attribute information is input and executed in the function execution logic corresponding to the specified function (e.g., YES in operation 1110), in operation 1120, the pre-condition module 825 may identify the corresponding function as a non-available function.

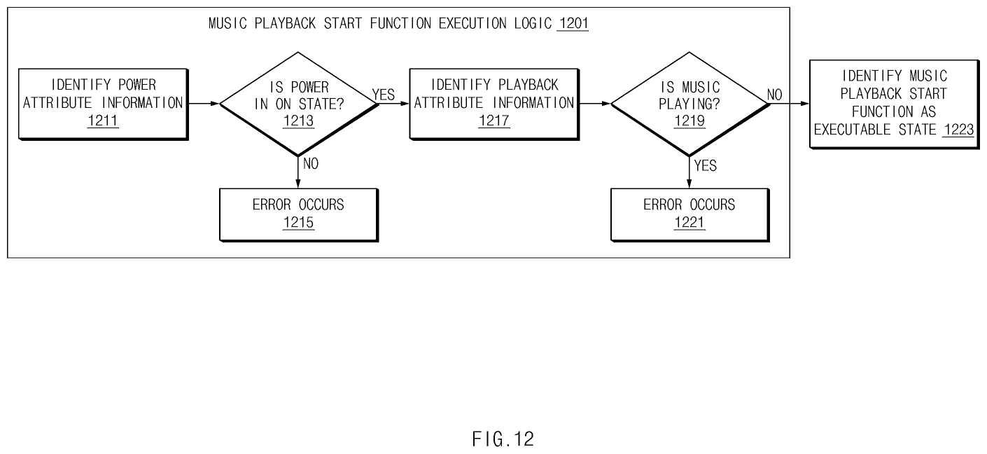

FIG. 12 illustrates a logic flow diagram of a music playback start function according to an embodiment of the disclosure.

Referring to FIGS. 8 and 12, music playback start function execution logic 1201 may include a plurality of conditions that may generate an error according to attributes. For example, the execution logic 1201 may be set by the manufacturer of the external device 841.

In operation 1211, the execution logic 1201 may identify power attribute information. The power attribute information may be, for example, one piece of attribute information received from the external device 841. The power attribute information may indicate that the power of the external device 841 is in an ON state or an OFF state.

In operation 1213, the execution logic 1201 may determine whether the power is in an ON state. If the power is off (e.g., NO in operation 1213), the execution logic 1201 may generate an error in operation 1215. This is because, if the power is off, music playback may not be possible. If an error occurs, the execution logic 1201 may return the error and end the procedure without performing a subsequent step.

If the power is on (e.g., YES in operation 1213), in operation 1217, the execution logic 1201 may identify playback attribute information. The playback attribute information may be, for example, one piece of attribute information received from the external device 841. The playback attribute information may indicate that the music playback function of the external device 841 is playing or stopped.

In operation 1219, the execution logic 1201 may determine whether the music is playing. The execution logic 1201 may determine whether music is being played in the external device 841 by using the attribute information. If the external device 841 is playing music (e.g., YES in operation 1219), the execution logic 1201 may generate an error in operation 1221. This is because, when music is already being played, it may not be possible to perform music playback. If an error occurs, the execution logic 1201 may return the error and end the procedure without performing a subsequent step.

If the external device 841 is not playing music (e.g., NO in operation 1219), in operation 1223, the execution logic 1201 may identify the music playback start function as an executable state. For example, the execution logic 1201 may identify the music playback start function of the external device 841 as an available function (e.g., operation 1115 of FIG. 11).

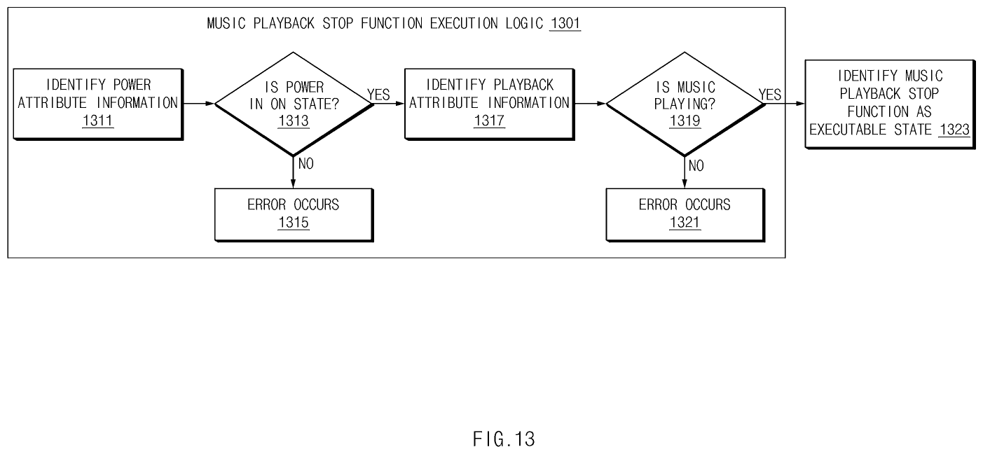

FIG. 13 illustrates a logic flow diagram of a music playback stop function according to an embodiment of the disclosure.

Referring to FIGS. 8 and 13, music playback stop function execution logic 1301 may include a plurality of conditions that may generate an error according to attributes. For example, the execution logic 1301 may be set by the manufacturer of the external device 841.

In operation 1311, the execution logic 1301 may identify power attribute information. The power attribute information may be, for example, one piece of attribute information received from the external device 841. The power attribute information may indicate that the power of the external device 841 is in an ON state or an OFF state.

In operation 1313, the execution logic 1301 may determine whether the power is in an ON state. If the power is off (e.g., NO in operation 1313), the execution logic 1301 may generate an error in operation 1315. This is because, if the power is off, music playback may not be possible. If an error occurs, the execution logic 1301 may return the error and end the procedure without performing a subsequent step.

If the power is on (e.g., YES in operation 1313), in operation 1317, the execution logic 1301 may identify playback attribute information. The playback attribute information may be, for example, one piece of attribute information received from the external device 841. The playback attribute information may indicate that the music playback function of the external device 841 is playing or stopped.

In operation 1319, the execution logic 1301 may determine whether the music is playing. The execution logic 1301 may determine whether music is being played in the external device 841 by using the attribute information. If the external device 841 is not playing music (e.g., NO in operation 1319), the execution logic 1301 may generate an error in operation 1321. This is because the music to be stopped is not being played. If an error occurs, the execution logic 1301 may return the error and end the procedure without performing a subsequent step.

If the external device 841 is playing music (e.g., YES in operation 1319), in operation 1323, the execution logic 1301 may identify the music playback stop function as an executable state. For example, the execution logic 1301 may identify the music playback stop function of the external device 841 as an available function (e.g., operation 1115 of FIG. 11).

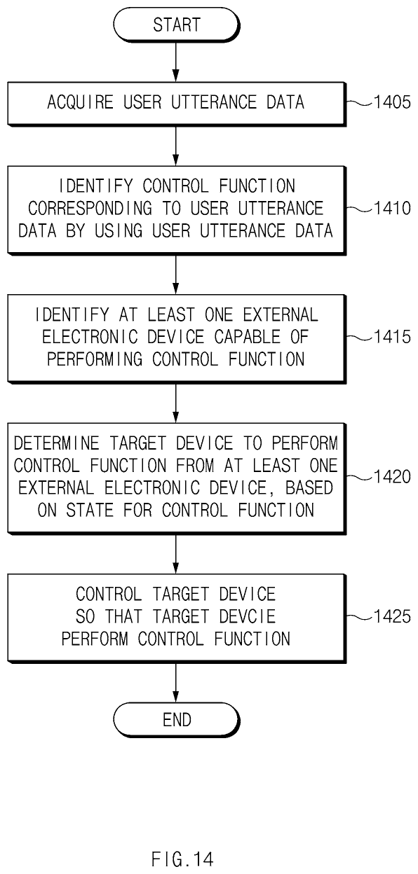

FIG. 14 illustrates a flowchart of a method for controlling a target device of an electronic device according to an embodiment of the disclosure.

Referring to FIGS. 7 and 14, the electronic device 701 may determine a target device to perform a control function corresponding to the utterance of the user, and control the target device so that the target device performs the control function.

In operation 1405, the electronic device 701 may acquire user utterance data. For example, the electronic device 701 may acquire user utterance data from an external device (e.g., the listener device 801 of FIG. 8). The user utterance data may include voice data corresponding to the utterance of the user or text data corresponding to the utterance of the user. For another example, the electronic device 701 may acquire utterance data from the user by using the audio circuitry 750 of the electronic device 701.

In operation 1410, the electronic device 701 may identify a control function corresponding to the user utterance data by using the user utterance data. For example, the electronic device 701 may identify an intent corresponding to the utterance data and identify a control function corresponding to the identified intent. As described above with reference to FIG. 8, the electronic device 701 may identify the control function corresponding to the intent by using the mapping relationship between the intent and the function. For example, the electronic device 701 may identify an intent by performing natural language understanding on utterance data, and identify the control function based on the intent. For another example, the electronic device 701 may identify the control function by transmitting the utterance data to another device and receiving the control function from the other device. In an embodiment of the disclosure, the control function may be referred to the intent.

In operation 1415, the electronic device 701 may identify at least one external electronic device capable of performing the control function. For example, the electronic device 701 may identify at least one external electronic device capable of performing the control function as described above with reference to Table 2. For example, the electronic device 701 may include a database (e.g., the function DB 822 of FIG. 8) for external electronic devices, and identify at least one external electronic device by using information in the database. For another example, the electronic device 701 may receive information on external electronic devices from another electronic device, and identify at least one external electronic device by using the received information. The update of the database for external electronic devices may be performed, for example, as described above with reference to FIG. 9.

In operation 1420, the electronic device 701 may determine a target device to perform the control function from at least one external electronic device, based on a state for the control function. For example, as described above with reference to Table 3, the electronic device 701 may identify an available function of at least one external electronic device and determine, as the target device, the external electronic device with the state in which the control function is available. For example, the electronic device 701 may include a database for available functions (e.g., the available function DB 823 of FIG. 8), and identify the target device by using information in the database. For another example, the electronic device 701 may receive information on available functions from another electronic device, and identify the target device by using the received information. The identification method for the available function may be referred to as described above with reference to FIGS. 10, 11, 12, and 13.

In operation 1425, the electronic device 701 may control the target device so that the target device performs a control function. For example, the electronic device 701 may control the target device by directly transmitting a signal to the target device. For another example, the electronic device 701 may control the target device by transmitting control information through another device.

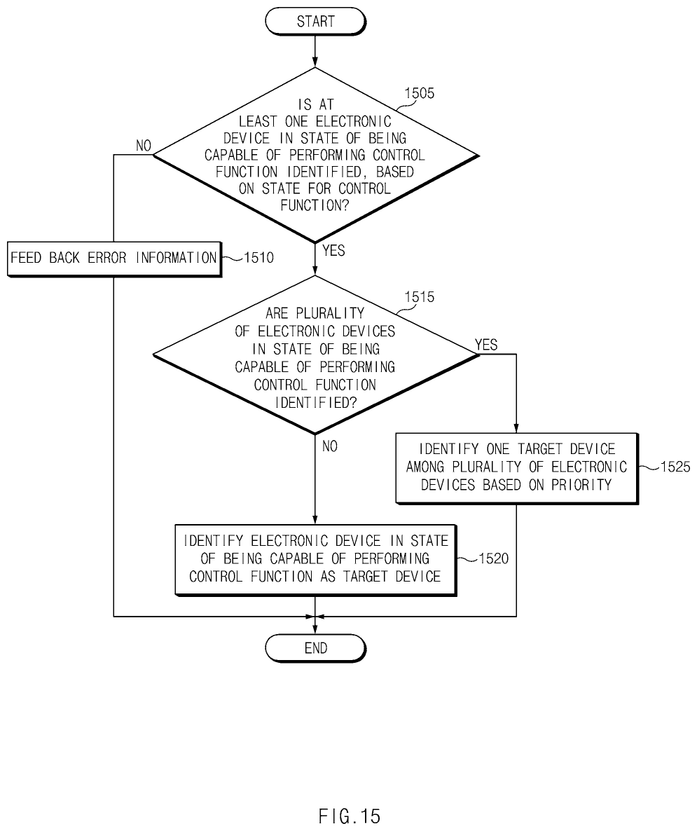

FIG. 15 illustrates a flowchart of a method for determining a target device of an electronic device according to an embodiment of the disclosure.

Referring to FIGS. 7 and 15, according to an embodiment of the disclosure, the electronic device 701 may identify a target device. For example, a method for determining a target device of FIG. 15 may correspond to operation 1420 of FIG. 14.

In operation 1505, the electronic device 701 may determine whether a target device in a state of being capable of performing a control function is identified, based on a state for the control function. If at least one electronic device in a state of being capable of performing the control function is not identified (e.g., NO in operation 1505), in operation 1510, the electronic device 701 may feed back error information to the user. Since a device capable of performing the control function corresponding to an utterance has not been found, the electronic device 701 may provide information indicating that an error has occurred to the user directly or through another device.

If at least one electronic device in a state of being capable of performing the control function is identified (e.g., YES in operation 1505), in operation 1515, the electronic device 701 may determine whether a plurality of electronic devices in the state of being capable of performing the control function are identified. If only one electronic device is identified, the electronic device 701 may determine that a plurality of electronic devices are not identified (e.g., NO in operation 1515). In this case, in operation 1520, the electronic device 701 may identify the electronic device in the state of being capable of performing the control function as the target device.

If a plurality of electronic devices are identified (e.g., YES in operation 1515), in operation 1525, the electronic device 701 may identify one target device among the plurality of electronic devices based on a priority. For example, if a listener device is included among electronic devices capable of performing the control function, the electronic device 701 may identify the listener device as the target device. For another example, the electronic device 701 may identify a device closest to the listener device as the target device. For still another example, the electronic device 701 may identify a device that is most frequently used for the corresponding control function as the target device. For still another example, the electronic device 701 may identify the target device based on complex priorities. The electronic device 701 may set the highest priority for the listener device, identify the device closest to the listener device as the target device if the distance may not be identified as the target device, and identify the target device based on the frequency of use if the distance between the target device and the listener device may not be identified.

Referring to FIGS. 14 and 15, according to an embodiment of the disclosure, the method for controlling a target device of an electronic device may include acquiring user utterance data (e.g., operation 1405 of FIG. 14), identifying a control function corresponding to the user utterance data by using the user utterance data (e.g., operation 1410 of FIG. 14), identifying at least one external electronic device capable of performing the control function (operation 1415 of FIG. 14), determining a target device to perform the control function from the at least one external electronic device based on a state of the at least one external electronic device for the control function (e.g., operation 1420 of FIG. 14), and controlling the target device such that the target device performs the control function (operation 1425 of FIG. 14).

For example, the determining of the target device (e.g., operation 1420 of FIG. 14) may include identifying availability of the control function of each of the at least one external electronic device, and determining, as the target device, an external electronic device available for the control function from the at least one external electronic device.

For example, the method for controlling a target device of an electronic device may further include receiving attribute information about each of the at least one external electronic device from each of the at least one external electronic device, and updating availability associated with functions of each of the at least one external electronic device by using each piece of the attribute information. The updating of availability may include updating the availability by executing execution logic associated with each of the functions using the attribute information. For example, the execution logic may be a preset logic (e.g., the execution logic described above with reference to FIGS. 12 and 13) for determining availability of a function corresponding to the execution logic using the attribute information as a parameter.

The identifying of the at least one external electronic device capable of performing the control function (e.g., operation 1415 of FIG. 14) may include identifying an intent corresponding to the user utterance data, identifying a control function corresponding to the intent, and identifying the at least one external electronic device supporting the control function by using function information on a plurality of external electronic devices.

The determining of the target device (e.g., operation 1420 of FIG. 14) may include determining the target device based on a priority (e.g., YES in operation 1515 of FIG. 15) if the at least one external electronic device includes a plurality of external electronic devices (e.g., YES in operation 1515 of FIG. 15). For example, the determining of the target device based on the priority (e.g., operation 1525 of FIG. 15) may include determining, as the target device, a listener device that has acquired the user utterance data if the listener device is included among the plurality of external electronic devices. For another example, the determining of the target device based on the priority (e.g., operation 1525 of FIG. 15) may include receiving the user utterance data from the listener device, receiving location information about the listener device from the listener device, and determining, as the target device, an external electronic device closest to the listener device from the plurality of external electronic devices by using the location information. For still another example, the determining of the target device based on the priority (e.g., operation 1525 of FIG. 15) may include determining, as the target device, an external electronic device that is most frequently used, from the plurality of external electronic devices.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuitry;
at least one processor; and
a memory that stores instructions,
wherein the instructions, when executed by the at least one processor, cause the at least one processor to:
acquire user utterance data,
identify a control function corresponding to the user utterance data by using the user utterance data,
identify at least one external electronic device capable of performing the control function,
determine a target device to perform the control function from the at least one external electronic device based on a state of the at least one external electronic device for the control function, and
control the target device such that the target device performs the control function by using the communication circuitry.

2. The electronic device of claim 1, wherein the instructions, when executed by the at least one processor, further cause the at least one processor to:
identify availability of the control function of each of the at least one external electronic device; and
determine, as the target device, an external electronic device capable of using the control function from the at least one external electronic device.

3. The electronic device of claim 2, wherein the instructions, when executed by the at least one processor, further cause the at least one processor to:
receive attribute information about each of the at least one external electronic device from the external electronic device; and
update availability associated with functions of each of the at least one external electronic device by using each piece of the attribute information.

4. The electronic device of claim 3, wherein the instructions, when executed by the at least one processor, further cause the at least one processor to update the availability by executing execution logic associated with each of the functions using the attribute information.

5. The electronic device of claim 4, wherein the execution logic is a preset logic for determining availability of a function corresponding to the execution logic using the attribute information as a parameter.

6. The electronic device of claim 1, wherein the instructions, when executed by the at least one processor, further cause the at least one processor to:
identify an intent corresponding to the user utterance data;
identify the control function corresponding to the intent; and
identify the at least one external electronic device supporting the control function by using function information on a plurality of external electronic devices.

7. The electronic device of claim 1, wherein the instructions, when executed by the at least one processor, further cause the at least one processor to determine the target device based on a priority if the at least one external electronic device includes a plurality of external electronic devices.

8. The electronic device of claim 7, wherein the instructions, when executed by the at least one processor, further cause the at least one processor to determine, as the target device, a listener device that has acquired the user utterance data if the listener device is included among the plurality of external electronic devices.

9. The electronic device of claim 7, wherein the instructions, when executed by the at least one processor, further cause the at least one processor to:
receive the user utterance data from a listener device;
receive location information about the listener device from the listener device; and
determine, as the target device, an external electronic device closest to the listener device from the plurality of external electronic devices by using the location information.

10. The electronic device of claim 7, wherein the instructions, when executed by the at least one processor, further cause the at least one processor to determine, as the target device, an external electronic device that is most frequently used, from the plurality of external electronic devices.

11. A method for controlling a target device of an electronic device, the method comprising:
acquiring user utterance data;
identifying a control function corresponding to the user utterance data by using the user utterance data;
identifying at least one external electronic device capable of performing the control function;
determining a target device to perform the control function from the at least one external electronic device based on a state of the at least one external electronic device for the control function; and
controlling the target device such that the target device performs the control function.

12. The method of claim 11, wherein the determining of the target device includes:
identifying availability of the control function of each of the at least one external electronic device; and
determining, as the target device, an external electronic device capable of using the control function from the at least one external electronic device.

13. The method of claim 12, further comprising:
receiving attribute information about each of the at least one external electronic device from the external electronic device; and
updating availability associated with functions of each of the at least one external electronic device by using each piece of the attribute information.

14. The method of claim 13, wherein the updating of availability includes updating the availability by executing execution logic associated with each of the functions using the attribute information.

15. The method of claim 14, wherein the execution logic is a preset logic for determining availability of a function corresponding to the execution logic using the attribute information as a parameter.

16. The method of claim 11, wherein the identifying of the at least one external electronic device capable of performing the control function includes:
identifying an intent corresponding to the user utterance data;
identifying the control function corresponding to the intent; and
identifying the at least one external electronic device supporting the control function by using function information on a plurality of external electronic devices.

17. The method of claim 11, wherein the determining of the target device includes determining the target device based on a priority if the at least one external electronic device includes a plurality of external electronic devices.

18. The method of claim 17, wherein the determining of the target device based on the priority includes determining, as the target device, a listener device that has acquired the user utterance data if the listener device is included among the plurality of external electronic devices.

19. The method of claim 17, wherein the determining of the target device based on the priority includes:
receiving the user utterance data from a listener device;
receiving location information about the listener device from the listener device; and
determining, as the target device, an external electronic device closest to the listener device from the plurality of external electronic devices by using the location information.

20. The method of claim 17, wherein the determining of the target device based on the priority includes determining, as the target device, an external electronic device that is most frequently used, from the plurality of external electronic devices.
